(19) United States
(12) Patent Application Publication
(10) Pub. No.: US 2023/0084581 A1
(43) Pub. Date: Mar. 16, 2023

(54) VIDEO GAME CONTROLLER WITH A GRAPHICAL USER INTERFACE

(71) Applicant: Voyetra Turtle Beach Inc., White Plains, NY (US)

(72) Inventors: Andrew Brian Young, Newport, Wales (GB); Stephen Thomas Bright, Wales (GB); Daniel Adam Nuth, Newport (GB)

(21) Appl. No.: 17/477,318

(22) Filed: Sep. 16, 2021

(51) Int. Cl. A63F 13/26; A63F 13/24

(52) U.S. Cl. CPC A63F 13/26; A63F 13/24

(57) ABSTRACT

This disclosure describes a game controller system that allows a user to access and adapt the features of a game controller as well as secondary actions associated with the gaming experience. The disclosed game controller system may comprise an app, on a device external from the game controller, that is operable to adjust settings and profiles of the game controller. These settings and profiles are viewable, by the user, from a screen on the game controller.

### BACKGROUND

Limitations and disadvantages of conventional game controllers will become apparent to one of skill in the art, through comparison of such game controllers with some aspects of the present system set forth in the remainder of this disclosure with reference to the drawings.

### BRIEF SUMMARY

A video game controller with a graphical user interface is provided substantially as illustrated by and/or described in connection with at least one of the figures, as set forth more completely in the claims.

### BRIEF DESCRIPTION OF THE DRAWINGS

FIG. 1 illustrates an exemplary video game controller with a graphical user interface in a first configuration in accordance with aspects of this disclosure.

FIG. 2A illustrates an exemplary video game controller with a graphical user interface in a second configuration in accordance with aspects of this disclosure.

FIG. 2B illustrates an exemplary video game controller with a graphical user interface displaying a pop-up on top of the second configuration in accordance with aspects of this disclosure.

FIG. 3 illustrates an exemplary video game controller and an associated app running on a mobile device in accordance with aspects of this disclosure.

### DETAILED DESCRIPTION

This disclosure describes a game controller system that allows a user to access and adapt the features of a game controller as well as secondary actions associated with the gaming experience. The disclosed game controller system may comprise an application (“app”), on a device external from the game controller, that is operable to adjust settings and profiles of the game controller. These settings and profiles are viewable, by the user, from a screen on the game controller. The app may be a PC app, a windows app, or a Mac app. The app may also be a mobile app for a smartphone and/or tablet.

Certain embodiments of the disclosure may be found in a game controller with a user interface. In accordance with various embodiments of the disclosure, a device, such as a smartphone or tablet, may control settings and profiles, used by the game controller, that may be displayed on the user interface of the game controller. The device may adapt and adjust the settings and profiles even while the game controller is being actively used during a game. The device may communicate with the game controller wirelessly via Bluetooth, Wi-Fi, or any other wireless protocol. The game controller, disclosed herein, is not platform-specific and may communicate with a game console wired or wirelessly via Bluetooth, Wi-Fi, or any other wireless protocol.

The disclosed game controller system offers responsive and reliable controls that improve a user's performance. In addition, the disclosed game controller system also delivers innovative applications of technology that improve a user's experience.

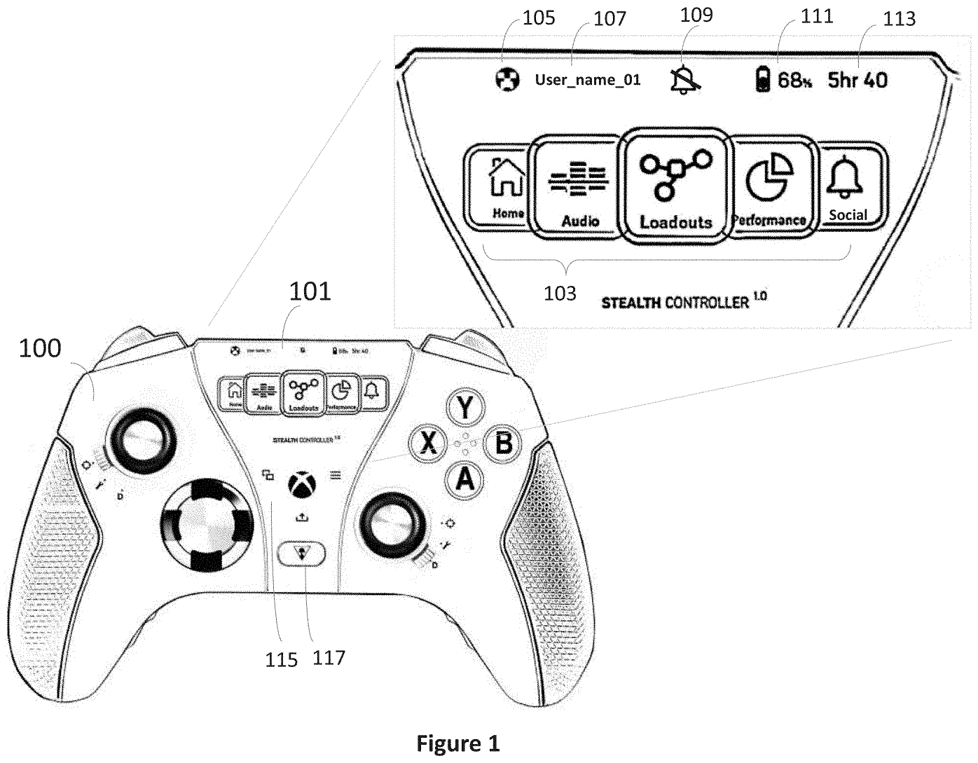

FIG. 1 illustrates an exemplary video game controller 100 with a graphical user interface 101 in a first configuration. The game controller 100 is configured to operate a video game and also comprises a memory, a processor and a screen 101. The video game may comprise a PC game, a console game, a mobile game a Mac game or any other electronic game. The memory in the game controller 100 is configured to store a setting for the game controller 100 and/or a profile associated with a user of the game controller 100. The processor in the game controller 100 is configured to access the memory. The screen 101 is operably coupled to the processor and is configured to display the setting and/or profile to the user of the game controller 100. The game controller 100 may comprise a wireless interface that is operable to communicate directly with a video game console. A dongle may be plugged into the video game console. For example, a USB connection on the video game console may be adapted, via the dongle, to communicate with the game controller 100 via Bluetooth.

The screen 101 is integrated with the game controller 100. The screen 101 may comprise a graphical user interface. The screen 101 may comprise a touch screen. For example, the screen 101 may comprise a capacitive touch display. The screen 101 may comprise a high resolution display with deep blacks and rich color. The screen 101 may be covered with a tempered glass. The glass may be configured with smooth 3D curves on the edges.

The screen 101 may display programmable settings and/or profiles. What and how elements are displayed is adjustable, via the processor, even while the game controller 100 is in use. The display on the screen 101 may provide a quick, in-game access to profiles and settings. The game controller 100 may comprises one or more buttons 117 for controlling what is displayed on the screen 101. The game controller 100 may also comprises one or more backlit controls 115.

The display elements may also enable and configure secondary features, functions and/or actions of the game controller 100. One such secondary function may be the audio of a game experience. The game controller 100 may comprise a jack for plugging in a headset or other type of speaker. Alternatively, the game controller 100 may communicate wirelessly (e.g., via Bluetooth or Wi-Fi) with a headset or other type of speaker. The screen 101 on the game controller 100 may be configured to adapt aspects of the audio processing to dynamically enhance the game.

The graphical user interface 101 in FIG. 1 illustrates a first exemplary display configuration. This first configuration comprises a menu of core features 103, a user icon 105, user name 107, a communication setting 109, a battery charge level 111, and an estimate time 113 until a battery must be recharged. This first configuration is a user-customizable dashboard that can be designed and redesigned by a user as desired for easy access to most frequently used features and to provide an overview of the controller 100 status. For example, an intuitive user interface may allow a user to quickly and easily change settings as desired.

Because the screen 101 is operable to display a customizable, user interface, the user interface may be configured to indicate primary features of the game controller and secondary features/actions of the game experience. The menu carousel 103 may be selectable by touch or the core feature set hubs may be accessed using the button 117. As illustrated in FIG. 1, the core hubs may comprise Home, Loadouts, Audio, Performance and Social. The Home hub may comprise a parameter display that a user wants to see most often. The Loadouts hub may comprise a selections of user profiles. The Audio hub may comprise controls for the secondary features/actions of a headset, microphone or other audio device. The Performance hub may comprise details on how various buttons on the game controller 100 are being used. The Social hub may comprise an interface to social media and other communication devices that may be external to the game console.

The user icon 105 and user name 107 may be selectable according to who is using the game controller 100 at any given time. The communication setting 109 may toggle between allowing and blocking communication via social media and other communication devices. The processor in the game controller 100 may be operable to control communication from an external device.

The game controller 100 may comprise a rechargeable battery. The battery charge level 111 and the estimate time 113 until a battery must be recharged are useful for indicating when a battery needs to be swapped or recharged. Recharging may be performed via a cable or a dedicated cradle.

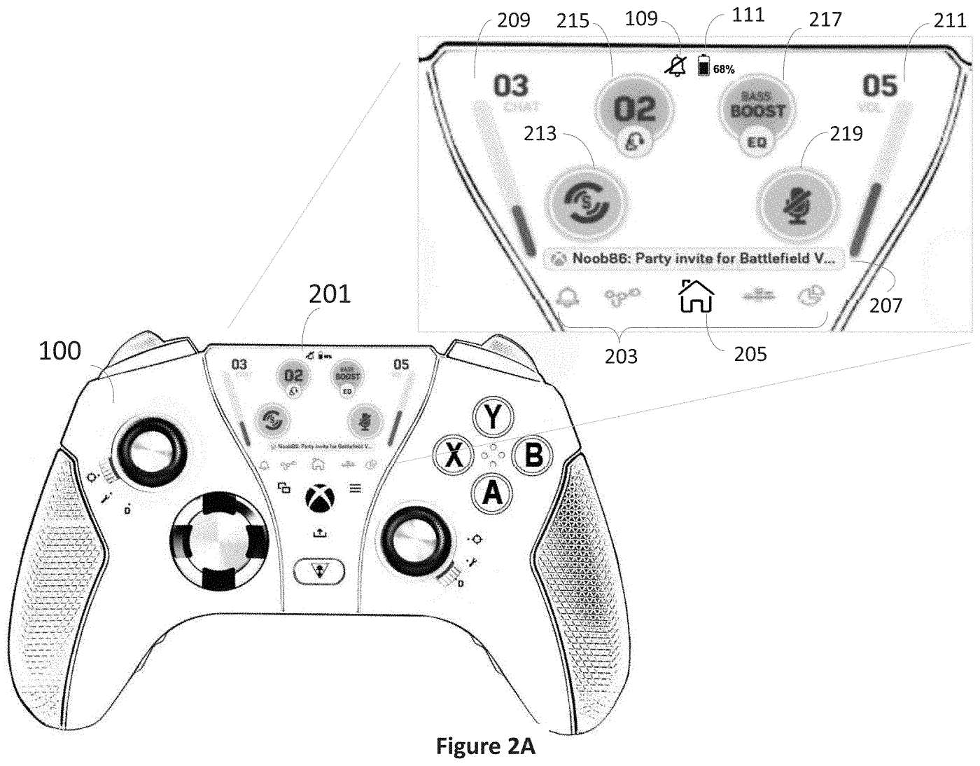

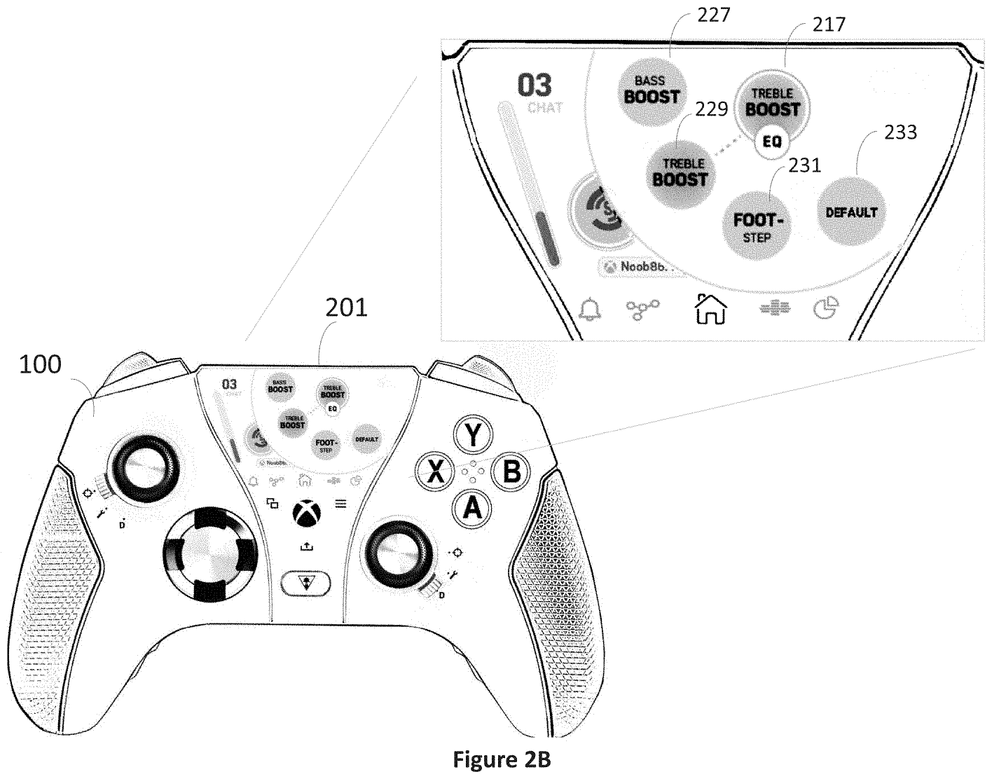

FIG. 2A illustrates an exemplary video game controller 100 with a graphical user interface 201 in a second configuration. The second exemplary display configuration comprises a set of menu icons 203. The current display corresponds to the Home hub, therefore the Home icon 205 is in the center and illuminated.

The second exemplary display 201 comprises customized screen elements such as a social media notice 207, a chat volume level slider 209, a game volume level slider 211, a Superhuman Hearing™ enable/disable toggle 213, a headset selector 215, an equalizer selector 217, and a microphone mute button 219. The second exemplary display 201 may also comprise the communication setting indicator 109 and the battery charge level indicator 111 as described with reference to the first exemplary display 101 in FIG. 1.

The social media notice 207 may be, for example, the most recent message among a plurality of messages in the Social hub. The chat volume level slider 209 may display, and allow control of, the chat volume heard via an associated audio output device. Likewise, the game volume level slider 211 may display, and allow control of, the game volume heard via an associated audio output device. The Superhuman Hearing™ enable/disable toggle 213 may display, and allow control of, whether a user has selected Turtle Beach's Superhuman Hearing™ technology. The headset selector 215 may be used to display, and allow control of, what particular headset (for example, a user or multiple users may have multiple headsets) is associated with the game controller 100. The equalizer selector 217 may be used to select from among a plurality of different equalizers. The microphone mute button 219 may be used to display, and allow control of, whether a user is muting the microphone of an associated headset.

FIG. 2B illustrates the exemplary video game controller 100 with a graphical user interface displaying a pop-up on top of the second configuration 201. When the equalizer selector 217 is pressed, a plurality of different equalizers buttons pop up. A user may have preprogrammed an equalizer with bass boost 227, an equalizer with treble boost 229, and an equalizer that boosts footsteps 231. There may also be a default equalizer 233. As illustrated in FIG. 2B, a user has pressed the equalizer selector 217 and selected the equalizer with treble boost 229.

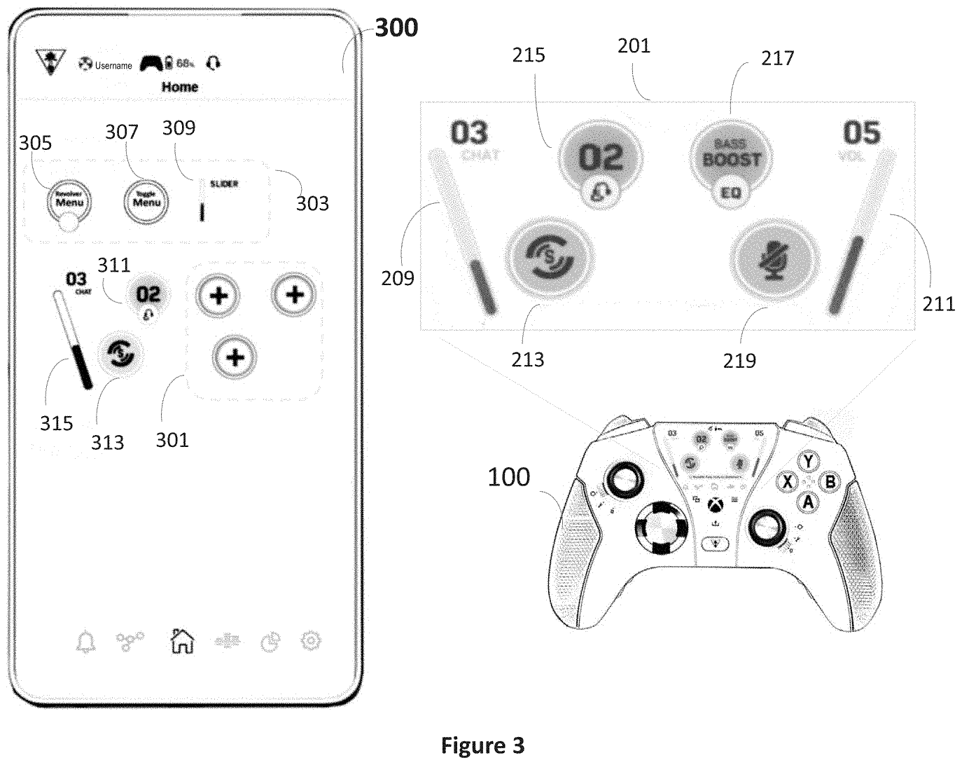

FIG. 3 illustrates an exemplary video game controller 100 and an associated app 300 running on a mobile device. As illustrated, the app 300 on the mobile device is currently being used to configure the second configuration 201 on the game controller 100. The app 300 on the mobile device may also be used to dynamically display and control all of the features of the game controller 100 as well as the secondary features.

The game controller system comprises an app 300 configured to operate on a device external from the game controller 100. The app 300 is operable to adjust the setting and profiles used by the game controller 100 even while the game controller 100 is in use. The device may be, for example, a smartphone or a tablet. The game controller 100 may comprise a wireless interface that is operable to communicate directly with the device. For example, in-depth game loadouts can be created on the companion app 300 and sent to onboard memory of the controller 100. The app 300 may also be enabled to access storage of a Cloud service provider and be powered by the Cloud. The app 300 may provide full access to the game controller 100 to customize and improve performance.

The user interface 201 is customizable via the app 300 on a device that is external to the game controller 100. As illustrated, the app 300 may provide a plurality of slots 301 for display elements 303. The display elements 303 may comprise a revolver menu 305 for selecting from a plurality of choices, a toggle menu 307 for selecting on/off or enable/disable, and a slider 309 for moving a parameter along a range of values.

The revolver menu 305 has been used to configure the headset selector 311 in the app 300. The headset selector 311 in the app 300 is associated with (e.g., controls and displays the setting of) the headset selector 215 in the user interface 201.

The toggle menu 307 has been used to configure the Superhuman Hearing™ enable/disable toggle 313 in the app 300. The Superhuman Hearing™ enable/disable toggle 313 in the app 300 is associated with (e.g., controls and displays the setting of) the Superhuman Hearing™ enable/disable toggle 213 in the user interface 201.

The slider 309 has been used to configure the chat volume level 315 in the app 300. The chat volume level 315 in the app 300 is associated with (e.g., controls and displays the setting of) the chat volume level 209 in the user interface 201.

Display elements 303 may be selectively placed into the slots 301 to further provide companion controls on the app 300 that are associated with the game volume level 211, the equalizer setting 217, and the microphone mute button 219 on the controller display 201.

While the present system has been described with reference to certain implementations, it will be understood by those skilled in the art that various changes may be made and equivalents may be substituted without departing from the scope of the present system. In addition, many modifications may be made to adapt a particular situation or material to the teachings of the present disclosure without departing from its scope. Therefore, it is intended that the present method and/or system not be limited to the particular implementations disclosed, but that the present system will include all implementations falling within the scope of the appended claims.

Throughout this disclosure, the use of the terms dynamically and/or adaptively with respect to an operation means that, for example, parameters for, configurations for and/or execution of the operation may be configured or reconfigured during run-time (e.g., in, or near, real-time) based on newly received or updated information or data. For example, an operation within a transmitter and/or a receiver may be configured or reconfigured based on, for example, current, recently received and/or updated signals, information and/or data.

The present method and/or system may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise first “circuitry” when executing a first one or more lines of code and may comprise second “circuitry” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

1. A system comprising:
a game controller configured to operate a video game, the game controller comprising:
a memory configured to store a setting for the game controller;
a processor configured to access the memory; and
a screen, operably coupled to the processor, configured to display the setting to a user of the game controller, wherein:
the setting is selectively located in one of a plurality of slots, wherein an ability to selectively locate the setting provides an interface layout that is customizable by the user of the game controller, and
the setting comprises one of a revolver menu, a toggle menu, and a slider.

2. The system of claim 1, wherein the system comprises an application (“app”) configured to operate on a device external from the game controller, wherein the app is operable to adjust the setting.

3. The system of claim 2, wherein the app is a mobile app and the device is a smartphone.

4. The system of claim 2, wherein the app is a mobile app and the device is a tablet.

5. The system of claim 2, wherein the game controller comprises a wireless interface operable to communicate directly with the device.

6. The system of claim 2, wherein the setting is adjustable, via the app, while the game controller is in use.

7. The system of claim 2, wherein the app is enabled to access storage of a cloud service provider.

8. A method comprising:
selecting a setting comprising one of a revolver menu, a toggle menu, and a slider;
locating the setting in a slot of a plurality of slots, wherein an ability to locate the setting provides an interface layout that is customizable by the user of the game controller;
storing the setting for a game controller in a memory of the game controller;
accessing, via a processor of the game controller, the setting stored in the memory; and
displaying the setting on a screen of the game controller according to the slot.

9. The method of claim 8, wherein the method comprises:
adjusting the setting via an application (“app”) operating on a device external from the game controller.

10. The method of claim 9, wherein the app is a mobile app and the device is a smartphone.

11. The method of claim 9, wherein the app is a mobile app and the device is a tablet.

12. The method of claim 9, wherein the method comprises:
wirelessly communicating between the device and the game controller.

13. The method of claim 9, wherein the setting is adjustable, via the app, while the game controller is in use.

14. The method of claim 9, wherein the method comprises:
accessing storage of a cloud service provider via the app.

15. A system comprising:
a non-transitory computer-readable medium storing a program, wherein when operated by a processor, the program causes the processor to execute a method comprising adjusting a setting of a video game controller, wherein a user is able to customize where the setting is displayed, on a screen of the game controller.

16. The system of claim 15, comprising the video game controller, wherein the video game controller comprises the non-transitory computer-readable medium and the processor.

17. The system of claim 15, comprising a mobile device, wherein the mobile device is external to the video game controller and comprises the non-transitory computer-readable medium and the processor.

18. The system of claim 17, wherein the mobile device is one of a smartphone and a tablet.

19. The system of claim 15, wherein the program is a mobile application (“app”) enabled to access storage of a cloud service provider.

20. The system of claim 15, wherein the game controller comprises a wireless interface operable to communicate with a mobile device.
